(19) United States
(12) Patent Application Publication
(10) Pub. No.: US 2020/0385955 A1
(43) Pub. Date: Dec. 10, 2020

(54) PORTABLE SAND PLANT SYSTEMS AND METHODS

(71) Applicant: Guidon Holdings, LLC, Houston, TX (US)

(72) Inventor: Alan Morris, Houston, TX (US)

(73) Assignee: Guidon Holdings, LLC, Houston, TX (US)

(21) Appl. No.: 16/519,758

(22) Filed: Jul. 23, 2019

Related U.S. Application Data
(60) Provisional application No. 62/858,371, filed on Jun. 7, 2019.

(51) Int. Cl. E02F 7/00; E02D 3/00; E04H 7/22; B08B 3/04

(52) U.S. Cl. CPC E02F 7/00; B08B 3/04; E04H 7/22; E02D 3/00

(57) ABSTRACT

A portable sand plant may include portable equipment disposed at a site adjacent to a fines recovery pit and a main mine pit. In addition, timber or composite matting may be laid on a surface of the site. The portable equipment is placed to form a portable wet plant and a portable dry plant directly on the surface of the site, or the timber or composite matting, or the combination thereof. Further, some of the portable equipment may be skid mounted. Furthermore, the portable sand plant may also include one or more relocatable sand storage buildings formed on the site.

### FIELD OF THE DISCLOSURE

Embodiments herein relate generally to portable sand plants for use in excavating, mining, refining and transportation of sand.

### BACKGROUND

Sand mining is an extraction of sand from an area of lands such as basins, inland dunes, beaches, ocean, and riverbeds. Sand is commonly used industrially, such as in manufacturing concrete. In some instances, sand may be used for hydraulic fracturing operations in oil and gas. Sand used for hydraulic fracturing is often referred to as frac sand. For example, frac sand may be a naturally occurring crystalline silica (quartz) sand that is processed from varying grades of sand deposits. In its make-up, frac sand differs from other types of sand, as grains size distributions of sand, the roundness and sphericity, crush strength, and purity of the sand, are major factors in the quality requirements for producing frac sand. These required frac sand properties lend themselves well to keep shale, and other formations, open long after hydraulic pressure is released to improve oil and gas transmissibility and thereby improving the productivity of these wells. When the high-pressure water or other fluids force the small perforations to become larger fractures, frac sand is pumped into these fractures, holding them open permanently to continue releasing oil and natural gas. Frac sand (or other types of natural or synthetic substances), when used to prop open these fractures, is called a “proppant.”

Frequently, frac sand may be obtained from a sand mine (e.g., frac sand mine) using a frac sand plant. Frac sand plants may be designed to mine, excavate, remove silt, clay, organics, and other impurities, as well as separate and dewater sand before drying, sizing and blending the sand into frac sand ready for use. Conventionally, sand plants may require permits that may take more than a year to be approved. Additionally, on-site water management is difficult both functionally, in managing stormwater runoff, and economically, regarding frac sand washing and drying applications. Further, the building of a conventional frac sand pant requires extensive foundation construction and crane support due to the size of equipment needed to process frac sand. Furthermore, the storage of dried sand takes up a lot of space. In conventional methods, silos are used for storage of the dried frac sand and adequately sized silos are neither portable nor cost-effective to be portable. In oil and gas basins that do not have “in-basin” frac sand, the cost of developing a frac sand mine is substantial and can exceed $100 million. Without proof of frac sand reserves in a potential new mine location, the risk of investing capital may exponentially rise without sufficient evaluation. Additionally, the area of land at which the sand may be mined must be tested to see if the sand deposit meets the American Petroleum Institute's (API) requirements, or specific customer requirements, for frac sand. Further, traditional permanent sand plant construction may take over a year to begin construction from breaking ground.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure is directed towards a method of forming and utilizing a portable sand plant that overcomes the shortcomings described above. Methods and systems in accordance with the present disclosure may allow a portable sand plant to be built in a compact area of land. Additionally, the portable sand plant may have timber or composite matting for portable equipment to be placed on, such that the portable equipment is easily assembled and dissembled which eliminates the need for concrete foundations, and concrete placement of any kind.

In one aspect, the present disclosure relates to a portable sand plant that may include portable equipment disposed at a site adjacent to a fines recovery pit and a main mine pit. In addition, timber or composite matting may be laid on a surface of the site. The portable equipment is placed to form a portable wet plant and a portable dry plant directly on the surface of the site, or the timber or composite matting, or the combination thereof. Further, some of the portable equipment may be skid mounted. Furthermore, the portable sand plant may also include one or more relocatable sand storage buildings formed on the site.

In another aspect, the present disclosure relates to a method for forming a portable sand plant. The method may include transferring portable equipment of the portable sand plant to a site adjacent to fines recovery pit and a main mine pit; laying timber or composite matting of the portable sand plant on a surface of the site; placing the portable equipment of the portable sand plant to form a portable wet plant and a portable dry plant directly on the surface of the site, or the timber or composite matting, or the combination thereof, wherein some of the portable equipment is skid mounted; and forming one or more relocatable sand storage buildings on the site.

In yet another aspect, the present disclosure relates to a method of using a portable frac sand plant. The method may include excavating sand from a fines recovery pit; feeding the excavated sand into a portable wet plant, wherein portable wet plant equipment of the portable wet plant is disposed directly on a surface of a land, or a timber or composite matting on the surface of the land, or skid or portable chassis mounted or the combination thereof; washing the excavated sand with the portable wet plant equipment and placing it in a washed sand stockpile for dewatering; transferring the washed sand from the washed sand stockpile to a portable dry plant, wherein portable dry plant equipment of the portable dry plant is disposed directly on the surface of a land, or the timber or composite matting on the surface of the land, or skid mounted or the combination thereof; drying the wet excavated sand with the portable dry plant equipment and screening it to form a frac sand; and storing the frac sand in one or more relocatable sand storage buildings of the portable sand plant.

In one or more aspects, the present disclosure relates to a method for forming a portable frac sand plant. The method may include removing a growth medium from a portion of a land, wherein the portion of the land forms a main mine pit and a fines recovery pit; transporting a portable sand plant to the land; laying timber or composite matting of the portable sand plant on a surface of the land adjacent to the main mine pit and the fines recovery pit; disposing portable equipment of the portable sand plant on the land adjacent to the main mine pit and the fines recovery pit, wherein the portable equipment form a portable wet plant and a portable dry plant; placing the portable equipment of the portable sand plant directly on the surface of the land, or the timber or composite matting on the surface of the land, or the combination thereof, wherein some of the portable equipment is skid mounted; excavating sand from the main mine pit and the fines recovery pit, wherein the portable wet plant washed the excavated sand and the portable dry plant dries the washed sand to form a finished sand; and testing and qualifying the product sand within a portable testing laboratory of the portable sand plant to determine if the finished sand meets operational requirements.

Other aspects and advantages will be apparent from the following description and the appended claims.

### BRIEF DESCRIPTION OF DRAWINGS

FIG. 1 illustrates a top view of a portable sand plant system in accordance with the present disclosure.

FIG. 2 illustrates a close-up view of a wet plant in the portable sand plant system of FIG. 1 in accordance with the present disclosure.

FIG. 3 illustrates a close-up view of a dry plant in the portable sand plant system of FIG. 1 in accordance with the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

The present disclosure relates to methods and systems for forming and enabling the construction of a portable sand plant. The methods and systems may include various portable equipment and finished product storage areas disposed on temporary timber or composite matting to reduce or eliminate concrete foundations and reduce ground disturbance in the portable sand plant. Further, the portable sand plant may operate 24 hours a day. Accordingly, the methods and systems disclosed herein may provide a time and cost efficient way to construct portable sand plants in a variety of conditions. In the portable sand plant, sand is initially mined from the ground and then transferred to a wet plant. Utilizing the wet plant, raw sand is washed to remove silt, debris, and clay particles. The sand slurry is then further processed through portable equipment needed to remove impurities from the sand, which in some embodiments may include, but not be limited to a series of screens, cyclones, attrition equipment, density separators, sand screws, blade mills, dewatering screens, or other minerals processing and dewatering equipment. Next, the sand is conveyed to a wet stockpile where excess water is further drained and recycled. Once the sand has sufficiently dewatered, the sand is loaded into a dry plant hopper where the sand is dried and screened to final size. With the sand dried, the final product is stored, ready for pickup and deployment to be used as a frac sand in hydraulic fracturing operations or other types of sands for various operations.

Portable sand plants, in one or more embodiments, may be constructed adjacent to a main mine pit and a fines recovery pit. The main mine pit and the fines recovery pit may be formed by removing a growth medium or overburden from a surface of the land. The growth medium or overburden may be stored in a stockpile on the site and may consist of materials such as sand, gravel, rock, clay, silt, organics, or other materials as may be found within the surface of the land. Additionally, the portable sand plant may include portable equipment for a wet plant and a dry plant. Each of the portable equipment components of the wet plant and the dry plant may be modular, skid mounted, and/or mounted on a portable chassis to make the wet plant and the dry plant portable. To additionally aid in the portable of the wet plant and the dry plant, some or all of the portable equipment of said respective portable plants may be disposed on timber or composite matting that may be laid out adjacent to the main mine pit and the fines recovery pit. Further, in a non-limiting example one or more sand storage buildings may be placed near the dry plant on timber or composite matting, or only the interior floor may only be matted. In a non-limiting example, the portable equipment of the portable wet plant and the portable dry plant may remain a trailer chassis for easy transportation and mobility. Further, the one or more sand storage buildings may include metal truss arches temporality anchored into the ground and may have a fabric or metal cover roof stretched on the metal truss arches. In some embodiments, a power system, such as natural gas or diesel generators may be used to power the portable equipment of the portable wet plant and the portable dry plant.

In a non-limiting example, the portable sand plant may allow for limited land disturbance permits to be issued and approved in much shorter time periods than the permit for a traditional (non-portable) frac sand plant. Additionally, the limited land disturbance permits may only allow the disruption of a very small area of land. One skilled in the art will appreciate how the portable sand plant may be built and used on the very small area of land. In a non-limiting example, flat portable storage may help alleviate space issues and allow for sufficient and economical on-site storage compared to alternatives such as portable silos which can only hold about 280 tons each. Further, the portable sand plant may have water reclamation systems that may be compact. Furthermore, portable equipment of the portable sand plant may be modular such that the equipment is smaller and portable to be disposed within very small areas of land. In some embodiments, the portable sand plant may eliminate or minimize the need for extensive foundation construction and crane support for the portable equipment of the portable sand plant. In addition, the portable sand plant may also eliminate or minimize the use of concrete in building for any part of the plant. It is further envisioned that the portable sand plant may allow mine operators to pay for resource development as OPEX instead of CAPEX, and significantly reduces the risk of the development of new in-basin sand locations.

Additionally, equipment selections for a permanent plant may also be verified or reviewed as a result of the portable sand plant's operations. One skilled in the art will recognize that one may review the performance of the portable sand plant and analogously select or verify permanent plant equipment components or subcomponents based on size, throughput capacity, retention time, energy requirements, water requirements, and a number of other factors that ultimately help reduce cost and risk for the permanent plant operator. An additional benefit of the portable sand plant may also include an ability to mobilize and install the portable sand plant quickly in a matter of several weeks. Traditional permanent sand plant construction which can take over a year to begin construction from breaking ground. One skilled in the art will understand the importance of getting product to market quickly helps establish a competitive advantage over competitors and how the portable sand plant may aid in getting product to market quickly.

Furthermore, one skilled in the art will appreciate how there are a number of additional added benefits and business cases for employing the portable sand plant following the permanent plant's construction. In a non-liming example, having a second plant (i.e. the portable sand plant) offers a form of “production insurance” as the system is completely independent from the permanent sand plant, and operational or equipment issues at the permanent plant may not impact the performance of operability of the portable sand plant. Secondly, the portable sand plant may offer supplemental production for the permanent sand plant operator. One skilled in the art will understand the importance of having additional production capabilities at the permanent sand plant. Third, the portable sand plant components, such as the portable dry plant or portable wet plant, may provide production balancing. In some instances, a permanent sand plant may be constructed and begin operation only to find that, for example, their dry plant is underperforming their wet plant by 150 tons per hour. A portable sand dryer may be employed separately from the rest of the portable sand plant and bring the permanent sand plant dry plant and wet plant production different to parity.

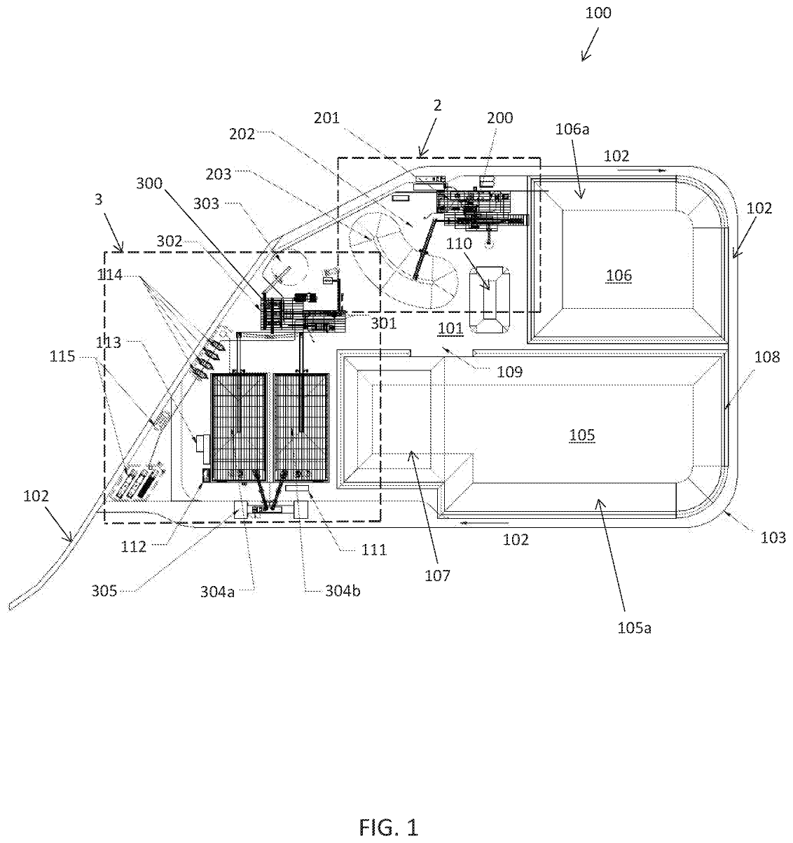

As outlined briefly above, the present disclosure relates to a system for constructing and using portable sand plants. Systems in accordance with the present disclosure may include some or all of the equipment described herein, as well as additional equipment. In general, the system may include equipment designed to build a portable sand plant and use the portable sand plant to excavate, mine, and refine sand, such as frac sand for hydraulic fracturing operations. FIG. 1 illustrates a portable sand plant 100 for producing sand located at an area of land 101 (i.e., a site) near a work site, such as a frac site. FIGS. 1-3 illustrate details of the portable sand plant 100. Like components are labeled with like numbers in FIGS. 1-3.

As illustrated in FIG. 1, in one or more embodiments, the portable sand plant 100 may be formed next to a road 102. Additionally, a perimeter 103 may be formed around the portable sand plant 100 by the road 102 on a side of the portable sand plant 100 and a traffic flow arrow 102 that runs counter-clockwise. In a non-limiting example, the perimeter 103 may enclose a limited number of acres of the land 101. The land 101 may be surveyed and after obtaining the required permits, the portable sand plant 100 may be constructed. In one or more embodiments, the portable sand plant 100 may be built adjacent to a main mine pit 105 and a fines recovery pit 106. The main mine pit 105 and fines recovery pit 106 may be formed by removing a growth medium/overburden from a portion of the land 101 to form a main mine pit 105 and a fines recovery pit 106. The growth medium/overburden may be stockpiled to overlay in a section 107 on the land 101 and may transition to another location within the land 101 as needed. In a non-limiting example, the growth medium/overburden may be removed from the land 101 and the stockpiled growth medium/overburden in the section 107 may be used for reclamation of the portable sand plant 100. It is further envisioned that additional growth medium may be removed from the perimeter road area(s) (102) to allow for road base material to be placed and compacted supporting site traffic. In addition, in the event that more raw sand is needed from the main mine pit 105, the growth medium stockpile may be moved to another location within the land 101.

In one or more embodiments, the main mine pit 105 and the fines recovery pit 106 may have a sloped surface 105a, 106a at an outer edge thereof. The sloped surface 105a, 106a of the pit outer edges may be limited to a natural angle of repose of the land 101. In a non-liming example, the main mine pit 105 and the fines recovery pit 106 may have any depth and volumetric size corresponding to any volumetric modeling of pit capacity designs as based on numerous other factors involved in mine planning. One skilled in the art will appreciate how other factors involved in mine planning have an impact on volumetric requirements for a fines recovery pond 106 and main mine pit 105. Additionally, the main mine pit 105 and the fines recovery pit 106 may have safety berms 108 around the outer edge of the respective pit. In a non-limiting example, the berms 108 around the main mine pit 105 and the fines recovery pit 106 may be sufficiently tall and wide to remain compliant with government regulations. In addition, the berms 108 may have an opening 109 such that the opening 109 is an entrance and exit of the main mine pit 105. In addition, the stockpiled growth medium may be side cast adjacent to the roads 102 to build the safety berms 108 as needed. One skilled in the art will appreciate how sand excavated and mined from the fines recovery pit 106 may be placed in a first stockpile 110 adjacent to the fines recovery pit 106 and the main mine pit area 105 may be used as a second stockpile.

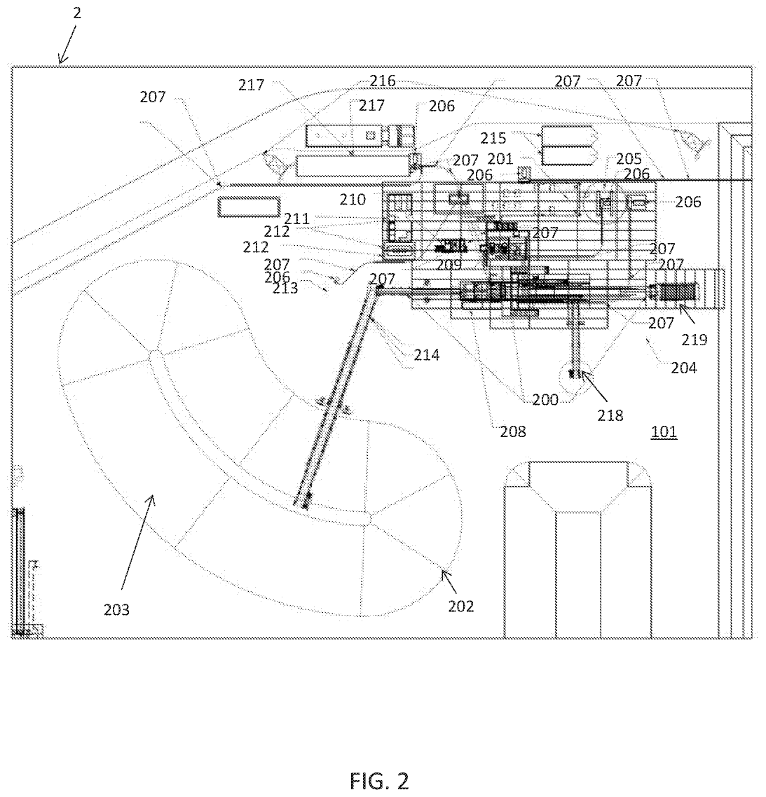

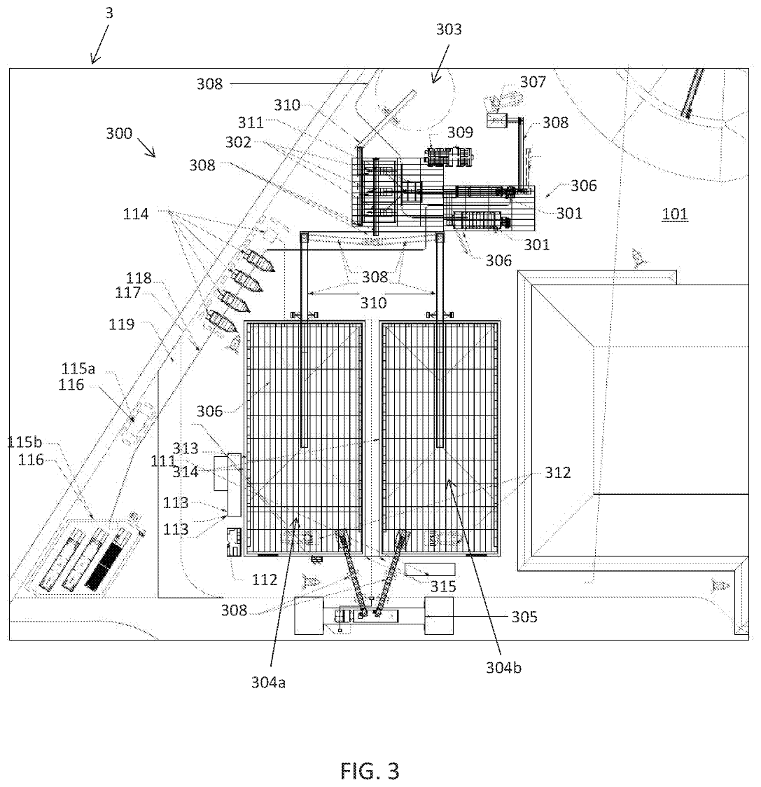

In some embodiments, within the perimeter 103, a portable wet plant 200 of the portable sand plant 100 may be disposed adjacent to the fines recovery pit 106 and a portable dry plant 300 of the portable sand plant 100 may be disposed adjacent to the main mine pit 105. The portable wet plant 200, which will be described in further detail in FIG. 2, may include a wide variety of equipment such as a portable water clarifier 201, a recoverable wet stockpile decant system 202, and any other portable equipment used for washing and removing deleterious material from the sand from and placing that deleterious material in the fines recovery pit 106. In addition, the portable wet plant 200 may be operationally associated with a washed sand stockpile 203, and any other portable equipment in association with washing and removing deleterious material from the sand. The portable dry plant 300, which will be described in further detail in FIG. 3, may include a wide variety of equipment such as a portable dryer and portable bag house 301, portable screen skids 302, and any other portable equipment used for drying, finishing, and storing the sand from the portable wet plant 200. In addition, the portable dry plant 300 may be operationally associated with an oversize stockpile 303, one or more relocatable sand storage buildings 304a, 304b and any other portable equipment used in association with drying, finishing, and storing the sand. In addition, a distribution facility 305 may be adjacent to the one or more sand storage buildings 304a, 304b to distribute sand (e.g., frac sand) from the portable sand plant 100 to a work site (e.g., frac sand).

Still referring to FIG. 1, other portable equipment or facilities at the portable sand plant 100 may include a portable storm shelter 111, portable office buildings 112, portable quality assurance and quality control (QA/QC) testing laboratories 113, portable power generators 114 (e.g., gas powered), portable fuel storage 115 (e.g., diesel and liquefied natural gas tanks (LNG)), and any other portable equipment to aid in the production of sand from the portable sand plant 100. It is further envisioned that all or some of the portable equipment within the portable sand plant 100 may be compact, modular, skid mounted (i.e., trailer chassis), portable, or the combination thereof. Additionally, one skilled in the art will appreciate how the portable sand plant 100 may not need concrete reinforcement or foundations for the portable equipment within the perimeter 103. In some embodiments, some of the portable equipment within the perimeter 103 may be disposed on timber or composite matting, or temporarily anchorable (e.g., via a recoverable helix anchor) to the land 101, or disposed directly on a surface of the land 101, or the combination thereof. The timber or composite matting may be constructed from dimensional lumber or composite materials and may be laid over the existing ground, side by side, to cover a required footprint for portable equipment to be placed thereon.

In some embodiments, the portable sand plant 100 may include a dust control system by using one or more water distributor trucks (not shown). Additionally, front end loaders and portable conveyers may be used to feed the portable wet plant 200 and the portable dry plant 300 with sand from the main mine pit 105 and the fines recovery pit 106. In addition, the front-end loaders and portable conveyers may also be used to load trucks at distribution facility 305 with sand. Further, earth moving equipment may be utilized at the portable sand plant 100 such as excavator(s), dozer(s), dump truck(s), loader(s), and water distributor(s), or any other equipment needed to move sand. One skilled in the art will appreciate how the excavation of sand from the main mine pit 105 and the fines recovery pit 106 may be done with any earth moving equipment and methods without departing from the present scope of the disclosure.

With the portable sand plant 100 assembled as shown in FIG. 1, sand may be mined, processed and transported to where the sand may be used by and end user in well construction or operations, such as for hydraulic fracturing at a frac site. In a non-limiting example, the main mine pit 105 may be excavated and the excavated sand may be placed in the first stockpile 110. The excavated sand may then be fed into the wet plant 200 from the first stockpile 110. Additionally, during the feeding process, the fines recovery pit 106 may slowly be filled with fine material from the washing process in the portable wet plant 200. It is further envisioned that a remaining volume in the fines recovery pit 106 may be utilized as storm water retention and sufficient freeboard system. The main mine pit 105 may also be used as a storm water retention system. The washed sand may be placed into the washed sand stockpile 203 and where the recoverable wet stockpile decant system 202 may aid in settling the washed sand. Once the washed sand has settled, the settled sand is fed into the portable dry plant 300 to be dried and finished to form a frac sand. The frac sand may then be stored in a first sand storage building 304a and a second sand storage building 304b. Trucks may travel on the road 102, in this specific example, in a clockwise manner around perimeter road 102 to arrive at the distribution facility 305, With the trucks at the distribution facility 305, the frac sand may be conveyed into the trucks from the first sand storage building 304a and/or the second sand storage building 304b so that the truck may transport the frac sand to a frac site.

Upon completion of the use of the portable sand plant 100, the portable equipment on the portable sand plant 100 may be disassembled and transported away from the land 101. Once all portable equipment has been removed from the land 101, site reclamation may begin and the growth medium stockpile in the section 107 within the main mine pit 105 may be spread over the main mine pit 105 and the fines recovery pit 106.

FIG. 2 illustrates a close-up view of the portable wet plant 200 of the portable sand plant 100 shown in box 2 of FIG. 1. In particular, a timber or composite matting 204 may be laid on a surface of the land 101. A plurality of portable equipment of the portable wet plant 200 may be placed on the timber or composite matting 204. In a non-limiting example, the portable water clarifier 201, a clear well 205, a plurality of pumps 206, a plurality of pipes 207, crane equipment 208, a scrubber system 209, a polymer make-up system 210, a control center 211, electronics 212, underground water storage tanks 213, a plurality of stackers 214, tool sheds 215, light generators 216, frac tanks 217, and any other equipment may be on or around the timber or composite matting 204. It is further envisioned that the plurality of portable equipment of the portable wet plant 200 may be skid mounted (i.e., a trailer chassis) such that vehicles or lifting equipment (i.e., a crane or forklift) may readily move said portable equipment. In some embodiments, the skid of said portable equipment may have connectors to allow for various portable equipment to be interchangeably connected to said portable equipment. In a non-limiting example, the portable water clarifier 201 may be mounted on a trailer chassis such that a vehicle may transport the portable water clarifier 201 and readily set the trailer chassis on the timber or composite matting 204. Additionally, the same or another vehicle may bring a second trailer chassis with the plurality of pumps 206 thereon and readily set the second trailer chassis next to the trailer chassis with the portable water clarifier 201. With both the portable water clarifier 201 and the plurality of pumps 206 in approximate each other, said clarifier 201 and pumps 206 may be readily connected to have the portable wet plant 200 operational.

Additionally, the recoverable wet stockpile decant system 202 may utilize a gravity drainage system, such as an oversized French drain, that is connected to underground pipes which drain to the underground water storage tanks 213 and pumped into the portable water clarifier 201 for reuse. It is further envisioned that the recoverable wet stockpile decant system 202 is provided underneath the washed sand stockpile 203. Further, excavated sand from the first stockpile 110 may be fed into the portable wet plant 200 through one or more portable hoppers 219.

FIG. 3 illustrates a close-up view of the portable dry plant 300 of the portable sand plant 100 shown in box 3 of FIG. 1. In particular, a timber or composite matting 306 may laid on a surface of the land 101. A plurality of portable equipment of the portable dry plant 300 may be placed on the timber or composite matting 306. In a non-limiting example, the portable dryer and portable bag house 301, the portable screen skids 302, the oversize stockpile 303, the one or more relocatable sand storage buildings 304a, 304b, a portable hopper 307, one or more portable conveyors 308, a portable control center 309, one or more portable sand stackers 310, a portable bucket elevator 311, front end loaders 312, and any other equipment may be on or around the timber or composite matting 306. It is further envisioned that the one or more relocatable sand storage buildings 304a, 304b may have sidewalls 313 formed from concrete blocks, an outer metal truss arch frame 314, and a covering 315 (e.g., a fabric or metal covering) laid over the outer metal frame 314. Furthermore, the outer metal frame 314 may be temporarily anchored to the surface of the land 101 with, for example, a recoverable helix anchor or any other type of anchor or support. It is further envisioned that the frac sand may be stored in the one or more relocatable sand storage buildings 304a, 304b, which may have a portable conveyor distribution system 308 attached thereof. In a non-limiting example, the front end loaders 312 may transport the frac sand from the one or more relocatable sand storage buildings 304a, 304b, through the portable conveyor distribution system 308 and into a truck for transportation to a work site (e.g., frac site).

In one or more embodiments, the plurality of portable equipment of the portable dry plant 300 may be skid mounted (i.e., a trailer chassis) such that vehicles or lifting equipment (i.e., a crane or forklift) may readily move said portable equipment. In some embodiments, the skid of said portable equipment may have connectors to allow for various portable equipment to be interchangeably connected to said portable equipment. In a non-limiting example, the dryer and bag house 301 may be mounted on a trailer chassis such that a vehicle may transport the dryer and bag house 301 and readily set the trailer chassis on the timber or composite matting 306. Additionally, the same or another vehicle may bring a second trailer chassis with the screen skids 302 thereon and readily set the second trailer chassis next to the trailer chassis with the dryer and bag house 301. With both the dryer and bag house 301 and the screen skids 302 in approximate each other, said dryer and bag house 301 and screen skids 302 may be readily connected to have the portable dry plant 300 operational.

Additionally, in adjacent areas near the portable dry plant 300, various other portable equipment may be placed such as the portable storm shelter 111, portable office buildings 112, a portable storm shelter 111, portable QA/QC testing laboratories 113, portable power generators 114 (e.g., gas powered), portable fuel storage 115 (e.g., diesel 115a and LNG 115 tanks and refueling tanks 116, gas lines 117, light generators 119, and any other equipment to aid in the production of sand from the portable sand plant 100. In addition, the test results from the portable QA/QC testing laboratories 113 may be done on site and in-real time, which may allow readily available test results of the sand in significantly reduced time to ensure that the sand meets API standards, as well as quality and quantity required for a hydraulic fracturing operation. It is further envisioned that if the results from the portable QA/QC testing laboratories 113 determine the sand within the land 101 is of usable quality, a full scale sand plant may be built to be more permanent than or in conjunction with the portable sand plant 100. Further, if a full scale sand plant is built or the sand within the land 101 fails to be of usable quality, in either event, the portable sand plant 100, all or components thereof, may be disassembled and moved to a new site or placed in storage until further use is needed. This is one of the many benefits of using the portable sand plant 100 to evaluate new potential mine locations, which may ultimately reduce geologic uncertainty and improve permanent frac sand plant equipment planning and design specifications.

In some embodiments, the portable sand plant 100 may be moved from the land once the job is finished and the frac sand meets operational requirements. Alternatively, if the produced frac sand fails to meet customer or API requirements, the portable frac sand plant 100 will be demobilize to a new site. Once the portable equipment from the portable sand plant is removed from the site, the site may be reclaimed by spreading the growth medium, from within the growth medium/overburden stockpile, around the main mine pit and the fines recovery pit and completing any other required reclamation work prior to completely demobilizing from the site.

As discussed throughout this application, the portable sand plant systems and methods disclosed herein may provide numerous advantageous effects. First, the portable sand plant may allow for faster and more efficient mobilization and demobilization of portable equipment and services in mining, excavating, and refining sand into a frac sand ready for use. Additionally, the portable sand plant may allow for the land reclamation costs to be significantly lower compared to typical mining operations. Second, due to the compactness of the portable sand plant, a permit may be obtained in a shorter time and less extensive manner than conventional plant construction permits. Third, the portable sand plant may be used effectively in different scenarios, such as proving out resources to oil and gas operators (i.e. prospecting), supplementing existing mine production (i.e. wet and dry plant), production insurance for existing mines (independent system from existing mines), and production balancing for existing mines (e.g. provide extra dry plant production if the dry plant cannot match the wet plant's production rate). Fourth, the portable sand plant may be used effectively in plant start-up production for new mines where plant construction may take up to a year before production can start. Fifth, the portable frac sand plant may offer insight into the actual equipment requirements of the permanent frac sand plant by evaluating the production performance of the portable frac sand plant and using that data to make permanent frac sand plant equipment and process decisions. Overall, the building and using of the portable sand plant systems and methods disclosed herein may significantly reduce the time and cost necessary to ready the sand plant for use, reuse, and disassembly.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A method for forming a portable frac sand plant, the method comprising:
removing a growth medium from a portion of a land, wherein the portion of the land forms a main mine pit and a fines recovery pit;
transporting a portable sand plant to the land;
laying timber or composite matting of the portable sand plant on a surface of the land adjacent to the main mine pit and the fines recovery pit;
disposing portable equipment of the portable sand plant on the land adjacent to the main mine pit and the fines recovery pit, wherein the portable equipment form a portable wet plant and a portable dry plant;
placing the portable equipment of the portable sand plant directly on the surface of the land, or the timber or composite matting on the surface of the land, or the combination thereof, wherein some of the portable equipment is skid mounted;
excavating sand from the main mine pit and the fines recovery pit, wherein the portable wet plant washed the excavated sand and the portable dry plant dries the washed sand to form a finished sand; and
testing and qualifying the product sand within a portable testing laboratory of the portable sand plant to determine if the finished sand meets operational requirements.

2. The method of claim 1, further comprising moving the portable sand plant from the land if the finished sand meets operational requirements or if the finished sand fails operational requirements to a new site.

3. The method of claim 1, further comprising:
forming a first sand stockpile from an excavated sand from the fines recovery pit adjacent to the portable wet plant equipment, and
forming a second sand stockpile from the excavated sand from the fines recovery pit in the main mine pit.

4. The method of claim 3, further comprising feeding the portable wet plant with the excavated sand from the first sand stockpile and the second sand stockpile fed into.

5. The method of claim 3, further comprising excavating the main mine pit after the second sand stockpile is depleted to fed into the portable wet plant equipment.

6. The method of claim 1, further comprising storing growth medium in a stockpile on a portion of the land.

7. The method of claim 6, further comprising reclaiming the land with the growth medium stockpile.

8. The method of claim 7, wherein the reclaiming comprises spreading the growth medium stockpile in the fines recovery pit and the main mine pit.

9. The method of claim 1, further comprising operationally connecting the portable equipment of the portable sand plant with each other.

10. The method of claim 9, wherein any of the portable equipment is removable or replaceable with additional portable equipment.

11. The method of claim 1, further comprising forming a road around the land, wherein a traffic flow on the road is in a clockwise or counter-clockwise motion.

12. The method of claim 1, further comprising retaining storm water within the fines recovery pit and/or the main mine pit.

13. A method of using a portable frac sand plant, the method comprising:
excavating sand from a fines recovery pit;
feeding the excavated sand into a portable wet plant, wherein portable wet plant equipment of the portable wet plant is disposed directly on a surface of a land, or a timber or composite matting on the surface of the land, or skid or portable chassis mounted or the combination thereof;
washing the excavated sand with the portable wet plant equipment and placing it in a washed sand stockpile for dewatering;
transferring the washed sand from the washed sand stockpile to a portable dry plant, wherein portable dry plant equipment of the portable dry plant is disposed directly on the surface of a land, or the timber or composite matting on the surface of the land, or skid mounted or the combination thereof;
drying the wet excavated sand with the portable dry plant equipment and screening it to form a frac sand; and
storing the frac sand in one or more relocatable sand storage buildings of the portable sand plant.

14. The method of claim 13, further comprising testing the frac sand within a portable testing laboratory.

15. The method of claim 14, further comprising transporting the frac sand from the one or more relocatable sand storage buildings to a work site if the frac sand meets customer and/or American Petroleum Institute's (API) requirements.

16. A method for forming a portable sand plant, the method comprising:
transferring portable equipment of the portable sand plant to a site adjacent to fines recovery pit and a main mine pit;
laying timber or composite matting of the portable sand plant on a surface of the site;
placing the portable equipment of the portable sand plant to form a portable wet plant and a portable dry plant directly on the surface of the site, or the timber or composite matting, or the combination thereof, wherein some of the portable equipment is skid mounted; and
forming one or more relocatable sand storage buildings on the site.

17. The method of claim 16, further comprising:
testing a sand stored one or more relocatable sand storage buildings on the site by using the portable testing laboratory,
qualifying the tested sand based on operational requirements, and
determining if the portable sand plant is to stay on the site or move to a new site based on results of the qualifying the tested sand.

18. The method of claim 16, wherein the site has a minimal footprint area to comply with regulatory requirements that allow for an expedited permitting process.

19. The method of claim 16, further comprising connecting a portable power system, at the site, to the portable wet plant and the portable dry plant.

20. The method of claim 16, wherein the forming of the one or more relocatable sand storage buildings comprises:
erecting a truss arch frame,
forming side walls with concrete blocks, and
laying a cover over the truss arch frame.

21. The method of claim 20, wherein the one or more relocatable sand storage buildings are placed on the timber or composite matting or only an interior floor of one or more relocatable sand storage buildings is timber or composite matted.
